(19) United States
(12) Patent Application Publication
(10) Pub. No.: US 2008/0059197 A1
(43) Pub. Date: Mar. 6, 2008

(54) System and method for providing real-time communication of high quality audio

(75) Inventors: Gary A. Jones, Cedar Hills, UT (US); Michael J. Berry, Draper, UT (US)

Correspondence Address: SHEEHAN PHINNEY BASS & GREEN, PA;c/o PETER NIEVES, 1000 ELM STREET, MANCHESTER, NH, 03105-3701, US

(73) Assignee: ChartLogic, Inc., Salt Lake City, UT (US)

(21) Appl. No.: 11/512,021

(22) Filed: Aug. 29, 2006

(51) Int. Cl. G10L 21/00

(52) U.S. Cl. 704/270.1

(57) ABSTRACT

A system and method for providing real-time communication of high-quality audio is provided. The system contains a series of audio devices and a series of client devices, where each client device is in communication with an audio device, and each client device is capable of converting analog signals received from an audio device, into digital data. In addition, a series of server devices is provided where each service device is capable of communicating with one of the series of client devices via a network, and each server device is capable of converting digital data received from a client device, into analog signals. A series of server computers is provided, each having a sound card. A connection between a server device and a server computer resulting in analog signals from the server device being directly received by the sound card located within the server computer.

### FIELD OF THE INVENTION

The present invention is generally related to telecommunication, and more particularly is related to providing real-time communication of high quality audio.

### BACKGROUND OF THE INVENTION

It is common in many professions for an individual to use a recording device to store information temporarily until transcription services can be provided. Unfortunately, transcription services are very expensive. As an example, medical transcription services are a $10 billion US market, and a $15 billion worldwide market in accordance with a recent survey conducted by Nuance, a leading provider of automatic speech recognition software. Specifically, transcription is a labor-intensive, costly process. Even when automatic speech recognition is utilized over telephone lines or through low fidelity digital files, medically trained human editors are required to “cleanup” inaccuracies of the transcription. Transcription is also time delayed, can be incomplete, and often is not reviewed properly prior to returning to the author or not reviewed by the author upon receipt, resulting in a significant number of errors. These factors affect overall cost of professions that utilize transcription services. Further, the delayed nature of such transcriptions can affect quality of care and outcomes.

Automatic speech recognition (ASR) software, such as, but not limited to, Dragon Naturally Speaking®, from Nuance Corp., provides substantial benefits to users. Specifically, ASR software alleviates the need for using the services of a human transcriber, and the associated costs. ASR software provides near real-time transcription technology, which accurately transforms speech into text for review and action at the point of recording.

Unfortunately, large-vocabulary automatic speech recognition applications require the ASR software to be installed on each computer at which a user performs automatic speech recognition. This is due to the lack of a method available to send quality audio from a microphone of a client to a server based ASR application. The large-vocabulary speaker-dependent ASR of today requires an audio quality in the range of 16-bits/sample, 11,025 samples/second, and low distortion without dropouts or excessive latency.

There are many different fields in which providing transcription services is familiar. One example, among others includes, but is not limited to, the medical profession. As an example, electronic medical record applications are typically installed on computers within a medical facility. Medical professionals may speak into automatic speech recognition and electronic medical record applications that may be used for automatic speech recognition. Most commonly, every examination room, at every remote satellite office, in addition to physician home computers and laptops that may access an electronic medical records database, have automatic speech recognition and electronic medical record applications installed therein. Such duplicitous systems are expensive and complex to maintain reliably given the environment in which they are used.

Approaches for providing remote automatic speech recognition exist, such as dictation to an automatic speech recognition software program over short distances using quality wireless microphones to transmit speech or using a network protocol such as voice over Internet protocol, to transmit speech over a network, or using standard telephone lines. These approaches can provide some of the functionality required for automatic speech recognition from a remote location. Unfortunately, remote automatic speech recognition suffers from many problems and limitations. Specifically, due to potential radio interference or computer processor delays, and due to the loss of sound quality attributed to compression, clipping, and/or limited range, it is difficult to assure consistent, high-quality audio transmission over any distance.

In addition to the above-mentioned, when transcribing from a remote location, it is beneficial to be capable of viewing transcribed text while speaking. In fact, in certain professions it is vital to be capable of viewing transcription text while speaking. Specifically, if transcription services are plagued with delays, it becomes difficult for an individual to maintain their train of thought during dictation. Unfortunately, it is well known that digital data is typically buffered while being received, resulting in significant delays in transcription. Latency associated with a telecommunication means utilized by a remote transcription service, results in elongated transcription delays, thereby making it difficult for a professional to continue dictating and maintaining his train of thought.

Thus, a heretofore unaddressed need exists in the industry to address the aforementioned deficiencies and inadequacies.

### SUMMARY OF THE INVENTION

Embodiments of the present invention provide a system and method for providing real-time communication of high-quality audio. Briefly described, in architecture, one embodiment of the system, among others, can be implemented as follows. The system contains a series of audio devices and a series of client devices, where each client device is in communication with one of the audio devices, and each client device is capable of converting analog signals received from an audio device, into digital data. In addition, a series of server devices is provided where each service device is capable of communicating with one of the series of client devices via a network, and each server device is capable of converting digital data received from a client device, into analog signals. A series of server computers is provided, each having a sound card. A connection between a server device and a server computer resulting in analog signals from the server device being directly received by the sound card located within the server computer.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating the real-time transcription system, in accordance with a first exemplary embodiment of the invention.

FIG. 2 is a schematic diagram further illustrating the client NetMic of FIG. 1.

FIG. 3 is a schematic diagram further illustrating the server NetMic of FIG. 1.

FIG. 4 is a block diagram further illustrating the server of FIG. 1.

FIG. 5 is a block diagram of the client computer of FIG. 1.

FIG. 6 is a flowchart illustrating an administration mode of the system of FIG. 1, in accordance with the first exemplary embodiment of the invention.

FIG. 7 is a flow chart illustrating use of the present transcription system, in accordance with the first exemplary embodiment of the invention.

FIG. 8 is a schematic diagram illustrating the real-time transcription system, in accordance with the second exemplary embodiment of the invention.

FIG. 9 is a block diagram further illustrating the server of FIG. 8.

FIG. 10 is a block diagram further illustrating a single server computer of a series of server computers, in accordance with the second exemplary embodiment of the invention.

FIG. 11 is a block diagram of the client computer of FIG. 8, in accordance with the second exemplary embodiment of the invention.

FIG. 12 is a flow chart illustrating use of the transcription system of FIG. 8, in accordance with the second exemplary embodiment of the invention.

FIG. 13 is a flow chart illustrating synchronization of a CODEC.

### DETAILED DESCRIPTION

The present real-time communication system and method provides a means for providing transmission of high quality audio with very little latency, which is ideal for real-time voice command and control, transcription, and other applications. High quality audio is audio that is suitable for real time speech recognition, where there is no quality or latency difference to a direct connection.

The present detailed description is specific to providing real-time transcription services at a remote location and local receipt of transcribed text in real-time, within a client-server model. However, as mentioned above, it should be noted that while the present description describes a process for providing real-time transcription services, due to real-time communication provided by the system, the system may also provide for real-time voice command and control of a remote computer in real-time, and for user identification. Therefore, while the following provides the example of using the real-time communication system and method for providing real-time transcription services, the present real-time communication system and method is not intended to be limited to such use exclusively.

Real-time transcription service is described in the present detailed description as two main embodiments. A first embodiment includes the combination of at least a client NetMic, a client computer, an audio device, a server NetMic, and a remote server having software stored therein. A second embodiment of the system and method includes multiple client NetMics, multiple client computers, multiple audio devices, multiple server NetMics, multiple server computers, and a remote server, where connection software is stored on the client computers, the server computers, and/or the remote server. It should be noted that structure and functionality of a NetMic is described below in additional detail and that the term “NetMic” is merely intended to refer to the device described herein as such.

The software mentioned above, also referred to herein as connection software, provides a means of routing full or half duplex audio from a client NetMic or audio device located anywhere on a local area network, wide area network, or Internet, to a user selectable server NetMic and audio device located elsewhere in the network, thereby creating a network audio bridge. Structure and functionality associated with a NetMic and the connection software provided on the server, are described in detail hereinafter.

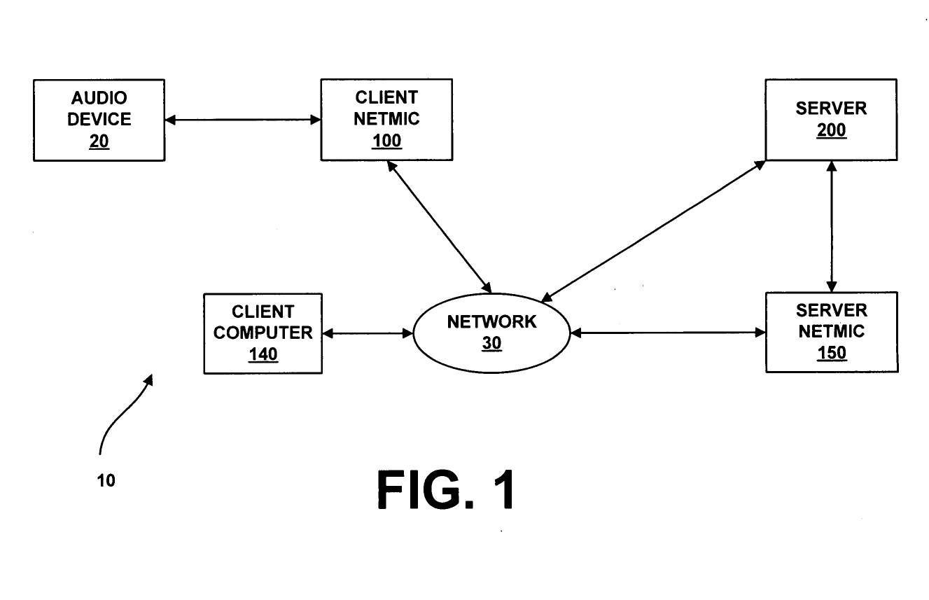

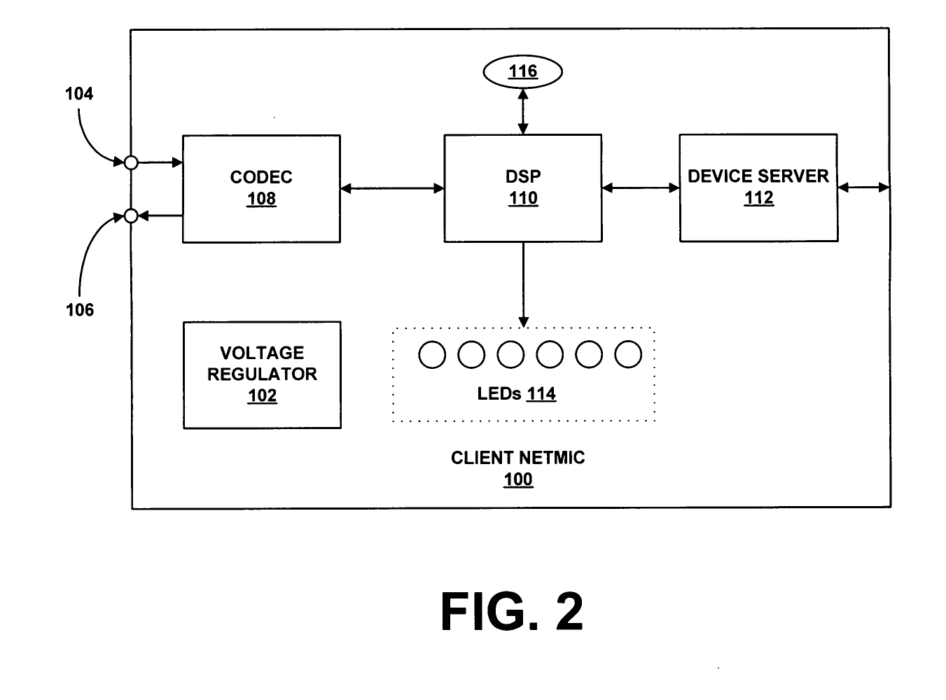

FIG. 1 is a schematic diagram illustrating the real-time communication system 10, in accordance with a first exemplary embodiment of the invention. As is shown by FIG. 1, an audio device 20 is located remote from a server 200. The audio device 20 is capable of providing analog audio to a client NetMic 100. The audio device 20 may be any device capable of receiving dictation from a user of the system 10, and converting the received audio from the user into an analog audio signal. Such audio devices 20 may include microphones, headsets, and other known devices. It should be noted that the audio device 20 may also be a device that is capable of storing received audio from a user and transmitting the audio to the client NetMic 100 as analog audio. A detailed description of the client NetMic 100 is provided in accordance with the description of FIG. 2, which is provided below.

Communication between the audio device 20 and the client NetMic 100 may be provided by a wired communication channel or a wireless communication channel. While FIG. 2 provides an example of a wired communication channel being provided between the audio device 20 and the client NetMic 100, this manner of communication is merely exemplary.

Returning to FIG. 1, the client NetMic 100 is capable of communication with a server NetMic 150 via a network 30. Specifically, as is described in detail with regard to FIG. 2, the client NetMic 100 is capable of converting analog audio received from the audio device 20, into digital audio for transmission to the server NetMic 150. It should be noted that the network 30 may be a local area network (LAN), or a wide area network (WAN), in which the Internet may be used for communication.

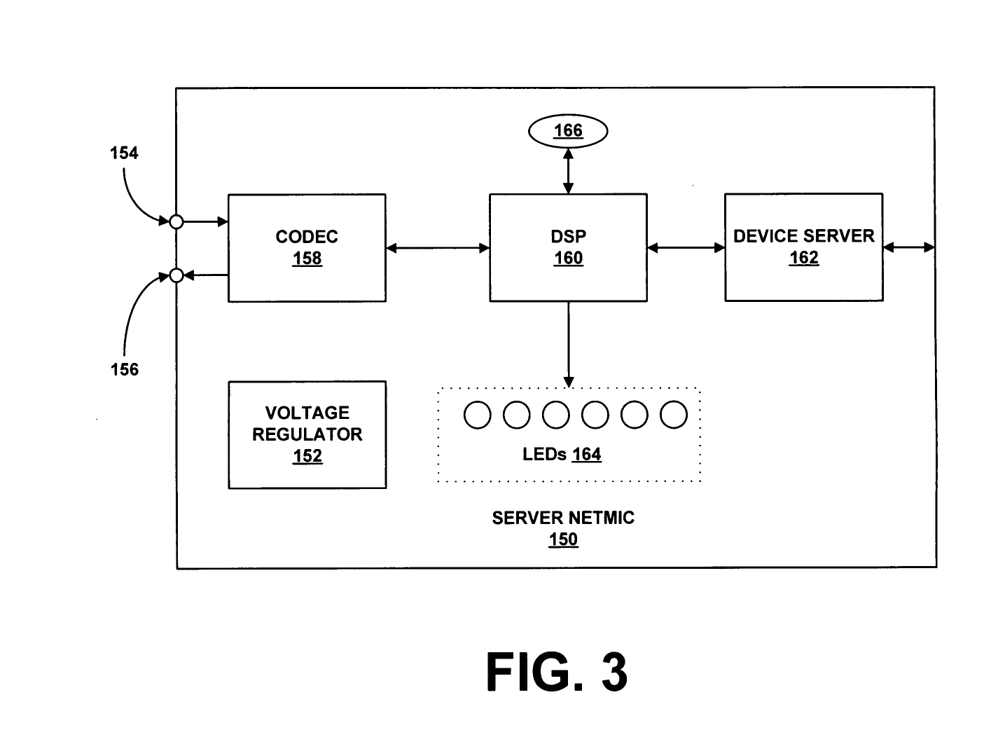

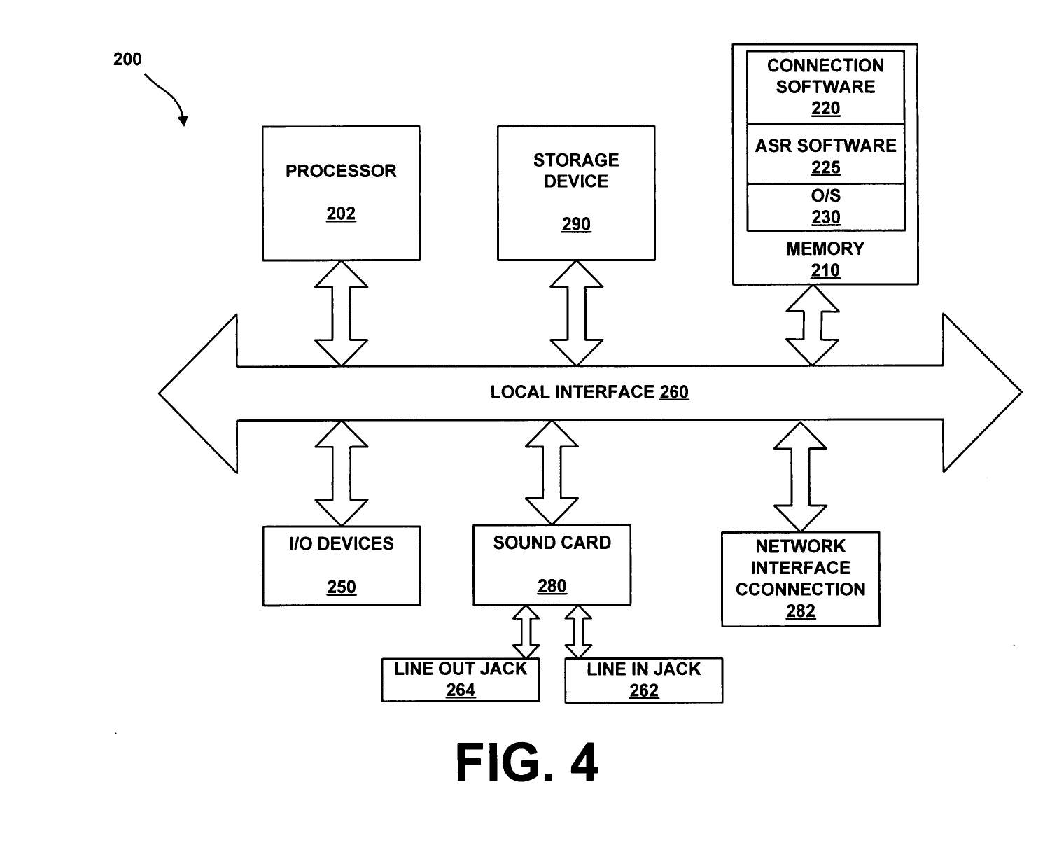

The server NetMic 150 is capable of converting digital audio received from the client NetMic 100 into analog audio for transmission to the server 200, or converting analog audio received from the server 200 into digital audio for transmission to the client NetMic 100, via the network 30. Communication between the server NetMic 150 and the server 200 is provided by a wired communication channel. Specifically, analog audio is provided from the server NetMic 150 to a line in jack of the server 200. The server NetMic 150 is described is detail with regard to FIG. 3, while the server 200 is described in detail with regard to FIG. 4, both of which are described in detail below. It should be noted that in accordance with an alternative embodiment of the invention, wireless communication may be provided from the server NetMic 150 to the server 200. For such wireless communication capability a wireless receiver would be connected to the line in jack of the server 200, while a wireless transmitter would be connected to the line out 106 of the server NetMic 150.

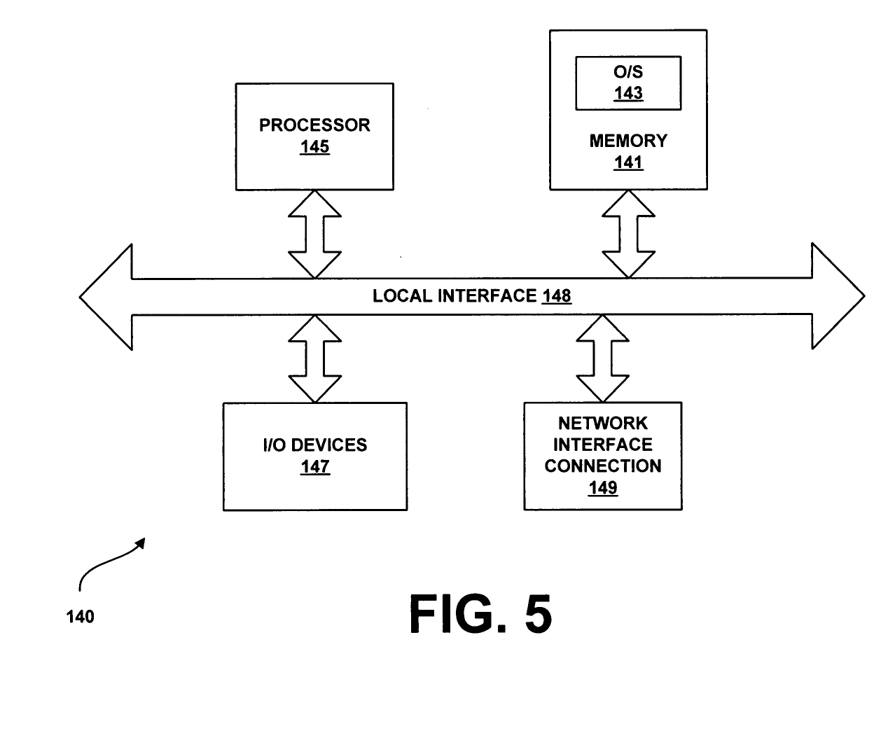

The system 10 of FIG. 1 also contains a client computer 140. The client computer 140 is capable of communicating with the server 200 via the network 30. Specifically, the client computer 140 is capable of receiving transcribed text, after transcription is performed by automatic speech recognition (ASR) software stored on the server 200 (as explained in detail below), from the server 200, via the network 30, and thereafter displaying the text on a screen in communication with the client computer 140. This process and alternatives are described in detail below. In addition, an example of a client computer 140 is provided below with regard to FIG. 5.

FIG. 2 is a schematic diagram further illustrating the client NetMic 100 of FIG. 1. As is shown by FIG. 2, the client NetMic 100 contains at least one voltage regulator 102. The voltage regulator 102 receives power from a wall mounted, DC power supply and generates DC voltages required by other circuitry within the client NetMic 100. It should be noted, that in accordance with an alternative embodiment of the invention, the voltage regulator 102 may receive power from a power source located internal to the client NetMic 100. Such a power source may be, but is not limited to, a battery power source capable of receiving removable batteries, or a battery power source having a non-removable battery that is capable of being recharged or receiving power from a universal serial bus or other interface to client computer 140.

The client NetMic 100 also contains a microphone jack 104 and a speaker jack 106 for allowing communication to and from the client NetMic 100, respectfully. The audio device 20 is capable of communicating with the client NetMic 100 through the microphone jack 104 and the speaker jack 106. It should be noted that in accordance with an alternative embodiment of the invention, the client NetMic 100 may contain a device for providing wireless communication with the audio device 20, in replacement of, or connected to the microphone jack 104 and the speaker jack 106. Since such a wireless communication device is known by those having ordinary skill in the art, further description of such a wireless communication device is not provided herein.

The client NetMic 100 contains an encoder/decoder (hereinafter, “CODEC”) 108, which is connected to a digital signal processor (DSP) 110. The CODEC 108 converts an analog audio signal received via the microphone jack 104, into digital data and sends the digital data to the DSP 110. As an example, the CODEC 108 may convert an analog audio signal to 16-bit I2C digital data and send the digital data to the DSP 110 at a rate of 11,025 samples per second. Conversely, the CODEC 108 converts the 16-bit I2C digital data received at the rate of 11,025 samples per second from the DSP 110, to analog audio, which is amplified and output to the speaker jack 106.

The DSP 110, located within the client NetMic 100 performs multiple functions. As an example, the DSP 110, may perform data conversion on full-duplex serial digital audio streams passed between the CODEC 108 and a device server 112 that is also located within the client NetMic 100. In addition, the DSP 110 monitors digital audio streams received from the CODEC 108 and generates signals to drive optional VU meter light emitting diodes (LEDs) 114. Optionally, the DSP 110, may cause the flashing of a heartbeat LED 116, to indicate that the DSP 110 is working properly.

An example of a device server 112 may be, but is not limited to, an XPort device server provided by Lantronix, Inc., of Irvine, Calif. The device server 112 is connected to the DSP 110, and performs multiple functions. As an example, the device server 112 may convert asynchronous serial data received from the DSP 110 to streaming Internet Protocol (IP) packets, which the device server 112 passes to a local area network (LAN). In addition, the device server 112 may convert streaming IP packets of data received from the LAN to asynchronous serial data, which the device server 112 passes to the DSP 110. It should be noted that the device server 112 contains a connection port therein for connecting to the network 30. Such a connection port may be, for example, but not limited to, an RJ-45 connection port, or a wireless data port. Preferably, the device server 112 also makes very efficient use of network bandwidth, adding only about 25% overhead in terms of bits sent over the network, due to network protocol, to the 11,025 16-bit samples per second of audio payload that is transmitted over the network.

Isolation within the client NetMic 100 is preferably provided between analog and digital circuitry to guarantee that electrical noise generated by the digital circuitry is not injected into audio signals.

FIG. 3 is a schematic diagram further illustrating the server NetMic 150 of FIG. 1. As is shown by FIG. 3, the server NetMic 150 contains at least one voltage regulator 152. The voltage regulator 152 receives power from a wall mounted DC power supply and generates DC voltages required by other circuitry within the server NetMic 150. It should be noted, that in accordance with an alternative embodiment of the invention, the voltage regulator 152 may receive power from a power source located internal to the server NetMic 150. Such a power source may be, but is not limited to, a battery power source capable of receiving removable batteries, or a battery power source having a non-removable battery that is capable of being recharged or receiving power from a universal serial bus or other interface to the server 200 or a server computer (later embodiment).

The server NetMic 150 also contains a line in jack 154 and a line out jack 156 for allowing communication from and to the server 200, respectfully. The line in jack 154 and the line out jack 156 of the server NetMic 150 permit direct communication with a soundcard located within the server 200, as is explained in further detail hereinbelow. It should be noted that soundcards referred to herein may be connected to the server, or server computer (in accordance with other embodiments of the invention), in numerous known manners. As an example, the soundcard may be a separate card connected within the server or server computer via a local bus, or the soundcard may be located directly on motherboard.

The server NetMic 150 contains a CODEC 158, which is connected to a DSP 160. The CODEC 158 converts an analog audio signal received via the line in jack 154 into digital data and sends the digital data to the DSP 160. As an example, the CODEC 158 may convert an analog audio signal to 16-bit I2C digital data and send the digital data to the DSP 160 at a rate of 11,025 samples per second. Conversely, the CODEC 158 converts the 16-bit I2C digital data received at the rate of 11,025 samples per second from the DSP 160, to analog audio, which is amplified and output to the line out jack 156.

The DSP 160, located within the server NetMic 150 performs multiple functions. As an example, the DSP 160 may perform data conversion on full-duplex serial digital audio streams passed between the CODEC 158 and a device server 162 that is also located within the server NetMic 150. In addition, the DSP 160 monitors digital audio streams received from the CODEC 158 and generates signals to drive optional VU meter LEDs 164. In addition, optionally, the DSP 160, may cause the flashing of a heartbeat LED 166, to indicate that the DSP 160 is working properly.

The device server 162 is connected to the DSP 160, and performs multiple functions. As an example, the device server 162 may convert asynchronous serial data received from the DSP 160 to streaming IP packets, which it passes to a LAN. In addition, the device server 162 may convert streaming IP packets of data received from the LAN to asynchronous serial data, which the device server 162 passes to the DSP 160. It should be noted that the device server 162 contains a connection port therein for connecting to the network 30. Such a connection port may be, for example, but not limited to, an RJ-45 connection port.

Isolation within the server NetMic 150, like the client NetMic 100, is preferably provided between analog and digital circuitry to guarantee that electrical noise generated by the digital circuitry is not injected into audio signals.

FIG. 4 is a block diagram further illustrating the server 200 of FIG. 1. Generally, in terms of hardware architecture, the server 200 includes at least one processor 202, a memory 210, and one or more input and/or output (I/O) devices 250 (or peripherals) that are communicatively coupled via a local interface 260. The local interface 260 can be, for example but not limited to, one or more buses or other wired or wireless connections, as is known in the art. The local interface 260 may have additional elements, which are omitted for simplicity, such as controllers, buffers (caches), drivers, repeaters, and receivers, to enable communication. Further, the local interface 260 may include address, control, and/or data connections to enable appropriate communication among the aforementioned components.

It should be noted that while the present detailed description provides the example of the server NetMic 150 being located separate from the server 200, in an alternative embodiment of the invention, the server NetMic 150 may be a card directly connected to the local interface of the server 200.

The processor 202 is a hardware device for executing connection software 220, particularly that stored in the memory 210. The processor 202 can be any custom made or commercially available processor, a central processing unit (CPU), an auxiliary processor among several processors associated with the server 200, a semiconductor based microprocessor (in the form of a microchip or chip set), a macroprocessor, or generally any device for executing software instructions.

The memory 210 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 210 may incorporate electronic, magnetic, optical, and/or other types of storage media. Note that the memory 210 can have a distributed architecture, where various components are situated remote from one another, but can be accessed by the processor 202.

The connection software 220 stored in the memory 210 may include one or more separate programs, each of which comprises an ordered listing of executable instructions for implementing logical functions. In accordance with the present invention, the connection software 220 defines functionality performed by the processor 202, in accordance with the present transcription system 10. As is described in detail hereinbelow with regard to administration of the present system 10, the connection software 220 allows for defining of communication paths and association within the system 10. Specifically, in accordance with the first exemplary embodiment of the invention, the connection software 220 allows an administrator of the system 10 to define an audio signal transmission path from a client NetMic 100 to a server NetMic 150. In addition, the connection software 220 may be used to specify which client computer 140 is associated with which client NetMic 100 for purposes of displaying transcribed text.

The memory 210 may also contain a suitable operating system (O/S) 230 known to those having ordinary skill in the art. The O/S 230 essentially controls the execution of other computer programs, such as the connection software 220, and provides scheduling, input-output control, file and data management, memory management, and communication control and related services.

The connection software 220 is a source program, executable program (object code), script, or any other entity comprising a set of instructions to be performed. When a source program, then the program needs to be translated via a compiler, assembler, interpreter, or the like, which may or may not be included within the memory 210, so as to operate properly in connection with the O/S 230. Furthermore, the connection software 220 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, and Java. In the currently contemplated best mode of practicing the invention, the connection software 220 is written as Microsoft .NET.

The memory 210 also has stored therein the ASR software 225. As is known by those having ordinary skill in the art, ASR software is capable of transcribing received audio signals into associated text. An example of ASR software may include, for example, but not limited to, Dragon Naturally Speaking®, from a Nuance Corp, located in Burlington, Mass. USA. In accordance with an alternative embodiment of the invention, as is explained herein, the ASR software may also be capable of providing user identification, where received audio signals are analyzed to identify a user that originally spoke, resulting in the audio signals. It should be noted that the ASR software used for providing user identification may be the ASR software that provides transcription, or it may be separate ASR software.

The I/O devices 250 may include input devices, for example but not limited to, a keyboard, mouse, scanner, microphone, and other devices. Furthermore, the I/O devices 250 may also include output devices, for example but not limited to, a printer, display, and other devices. Finally, the I/O devices 250 may further include devices that communicate both as inputs and outputs, for instance but not limited to, a modulator/demodulator (modem; for accessing another device, system, or network), a radio frequency (RF) or other transceiver, a telephonic interface, a bridge, a router, and other devices.

The server 200 also contains a line in jack 262 and a line out jack 264 for allowing communication from and to the server NetMic 150. The line in jack 262 and line out jack 264 of the server 200 allow for direct communication from the server NetMic 150 to a sound card 280 located within the server 200. Since the ASR software 225 is a high-accuracy, voice centric application, the NetMics 100, 150 are required to provide uncompressed, or lossless audio to achieve maximum performance and accuracy from the ASR software 225. These qualities are maintained by the NetMics 100, 150, and the connection between the server NetMic 150 and the server 200 is a direct wired connection from the server NetMic 150 to the sound card 280.

Alternatively, analog audio may be received from the server NetMic 150 via a universal serial bus (USB) connection located on the server 200. By providing communication capability between the server 200 and server NetMic 150 via either a line in jack 262, a line out jack 264, or a USB connection, a direct analog communication channel is provided between the server 200 and the server NetMic 150. Since direct communication with the sound card 280 provides immediate receipt of analog audio signals, there is no delay in received analog audio signals, such as is characteristic of audio signals received from a network connection. Specifically, audio signals received from a connection such as a network interface connection, are typically subject to buffering and loss of audio signals associated with interference. By receiving analog audio signals directly from the server NetMic 150 via the line in jack 262 of the server 200, received analog audio signals are transmitted directly to the sound card 280 resulting in such minimal buffering and/or interference, if any at all, so as to mimic a direct connection from a microphone directly to the sound card 280. After receipt by the sound card 280, received analog audio signals are transcribed in accordance with functionality defined by the ASR software 225.

The server 200 also contains a separate storage device 290 that, in accordance with the first exemplary embodiment of the invention, is capable of storing individual user specific voice files. The individual user specific voice files are used by the ASR software 225 to provide transcription specific to voice characteristics of an individual user. As is described in additional detail hereinbelow, the transcription system 10 is capable of providing automatic transcription for multiple users, through the use of the same client NetMic 100 or different client NetMics 100, where the client NetMics 100 may be located in the same location or in different locations. When a user of the transcription system 10 logs into a client computer 140, user specific voice files are accessed to allow transcription by the ASR software 225 stored within the server 200, where the transcription is specific to the logged in user.

Since the user specific voice files are stored within one storage device, within the server 200, the user specific voice files are not required to be resident in any other place but the server 200. This eliminates the need to continually update and distribute the user specific voice files over the network 30. It should be noted that in accordance with an alternative embodiment of the invention, the voice files may be located remote from the server and moved to the server upon necessity.

The server 200 also contains a network interface connection 282, or other means of communication, for allowing the server 200 to communicate within the network 30, and therefore, other portions of the system 10. Since network interface connections 282 are known to those having ordinary skill in the art, further description of such devices is not provided herein.

It should be noted that in accordance with the first exemplary embodiment of the invention, the server 200 is capable of transcribing text for more than one user located at more than one location, where one user is logged into the server 200 for transcription services at a time.

FIG. 5 is a block diagram of the client computer 140 of FIG. 1, in accordance with the first exemplary embodiment of the invention. As is shown by FIG. 5, the client computer 140 has a memory 141 with an O/S 143 stored therein, a processor 145, and I/O devices 147, each of which is capable of communicating within the client computer 140 via a local interface 148. The client computer 140 also contains a device for communication with the network 30, such as, but not limited to, a network interface connection (NIC) 149. It should be noted that the NIC 149 may be a wired or a wireless connection. Since basic descriptions of a memory 141, an O/S 143, a processor, I/O devices 147, and a local interface 148 have been provided hereinabove, further description is not provided herein. In accordance with an alternative embodiment of the invention, the client computer 140 may also contain a storage device therein.

As is mentioned in additional detail hereinbelow, transcribed text received by the client computer 140 is received by the NIC 149 and transmitted to an I/O device 147, such as a monitor, for review by the user of the audio device 20 and client computer 140. It should be noted that in accordance with an alternative embodiment of the invention, there may be more than one monitor in communication with the client computer 140, thereby allowing more than one individual to view transcribed text. In addition, more than one client computer 140, in more than one location, may be specified as a destination for transcribed text.

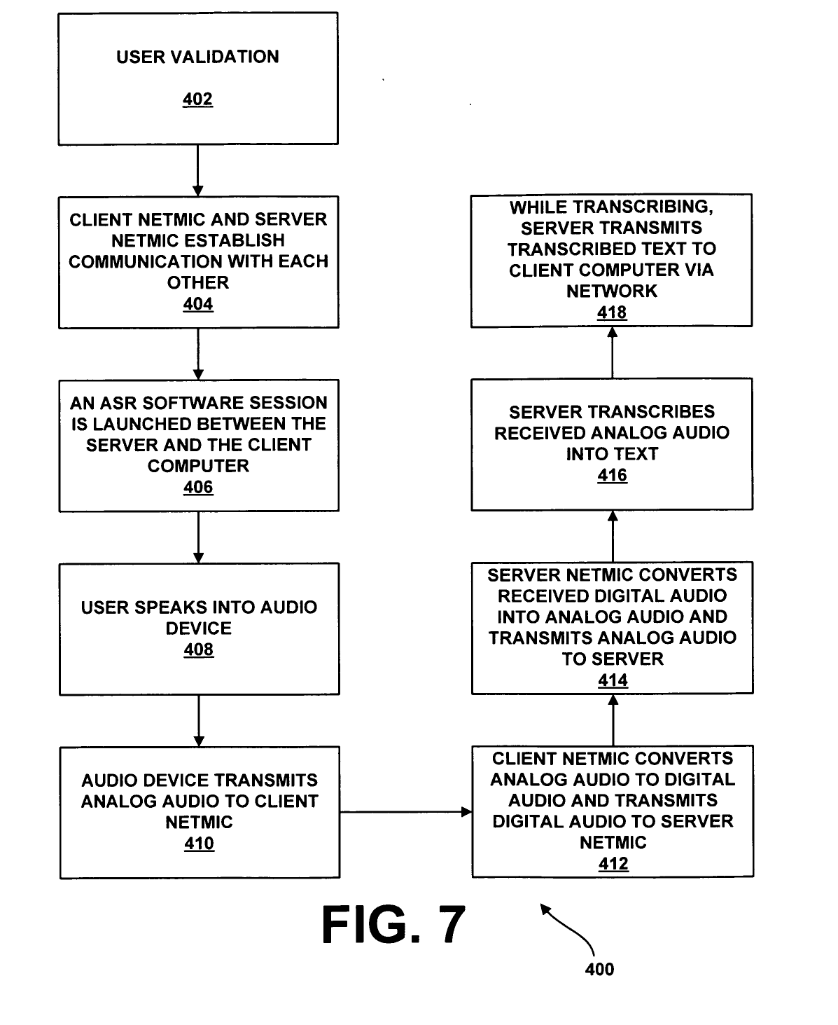

Prior to using the system 10 of FIG. 1, the system 10 is subject to an administration mode, when a path for transmitting analog and digital audio is defined, as well as association between portions of the system 10. FIG. 6 is a flowchart 300 illustrating the administration mode, in accordance with the first exemplary embodiment of the invention. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

In the first exemplary embodiment of the invention, all functionality is defined within the server 200, and a user of the system 10 utilizes transcription services provided by the system 10 by logging into the server 200 from a client computer 140, via, for example, a graphical user interface or web browser. It should be noted that, as is described in detail below, in accordance with the second exemplary embodiment of the invention, connection software is stored within the client computer 140 as well as the server 200, thereby resulting in use of the connection software stored within the client computer 140 and within the server 200 for purposes of providing communicating between the client computer 140 and the server 200.

To allow communication between the NetMics 100, 150, during the administrative mode, the client NetMic 100, and the server NetMic 150 are configured to allow communication therebetween (block 302). To configure the NetMics 100, 150, the NetMics 100, 150 are connected to the network 30. An Internet protocol (IP) address is then assigned to each NetMic 100, 150 as well as an IP address to each client computer 140 and server 200. Further, the administrative mode allows association of a given NetMic 100 to its co-located client computer 140 and a server NetMic 150 to its attached (via analog audio) server 200. Assigning of an IP address may be performed by an administrator manually assigning an IP address to each NetMic 100, 150, or by the system 10 automatically assigning IP addresses to the NetMics 100, 150 after selection by the administrator to automatically assign IP addresses to each NetMic 100, 150 connected to the Network 30. It should be noted that if the NetMics 100, 150 are communicating over the Internet, a virtual private network may be used between the NetMics 100, 150. In addition, the server 200 and the client computer 140 may communicate over a virtual private network.

Once the client NetMic 100 and the server NetMic 150 have been configured, the NetMics 100, 150 may continuously pass full-duplex audio over the system 10. Audio input on the client NetMic 100 microphone jack 104 will be present on the server NetMic 150 line out jack 156. In addition, audio input on the line in jack 154 of the server NetMic 150 is present on the audio jack J2 of the client NetMic 100.

As is shown by block 304, in accordance with the first exemplary embodiment of the invention, the client computer 140 displays a list of users that are capable of logging into the server 200 for purposes of using transcription services. A server 200 is then assigned to a user for transcription purposes (block 306). Assigning a user to a server 200 becomes especially important in embodiments having multiple servers 200. During assigning of a user to a server 200, location of user voice files is defined. In accordance with the first exemplary embodiment of the invention, the user voice files are located within the server 200. It should be noted, however, that in accordance with the second exemplary embodiment of the invention, user voice files are located remote from the server 200, as is explained in detail hereinbelow.

Returning to the description of FIG. 6, a client NetMic 100 is associated with a specific client computer 140 (block 308). By associating the client NetMic 100 with the specific client computer 140, text transcribed by the server 200 in response to audio received originally from the client NetMic 100, is forwarded by the server 200 to the client computer 140, for viewing by the user. While the server NetMIC 150 is assigned to the server 200, the client NetMIC 100 is also assigned to a client computer 140 in the administrative mode, but the audio path above is defined by the user log on for each session.

It should be noted that during administration mode users, servers, client NetMics, client computers, server NetMics, and server computers (in the second exemplary embodiment) may be added or removed. As an example, a series of new users may be identified, where each identified user is allowed access to the system. In addition, a user may be required to use a predefined password prior to being provided with access to the system.

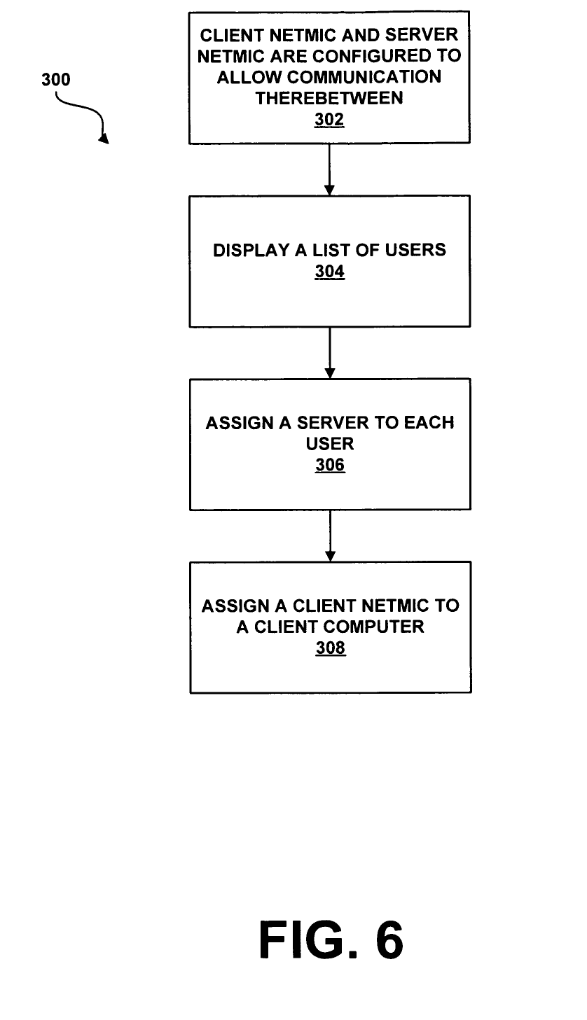

FIG. 7 is a flow chart 400 illustrating use of the present transcription system 10, in accordance with the first exemplary embodiment of the invention. As is shown by block 402, a user is validated for access to the server 200 (i.e., use of the system 10). For the user validation process, a user of the transcription system 10 logs into the server 200 through their client computer 140. Specifically, the user may use a graphical user interface made available at his client computer 140, to access the connection software 144 stored at the server 200. The server 200 receives the user identification and validates that the user identification is valid. Results of the user identification validation are displayed by a monitor or other output device in communication with the client computer 140. The validation process may also require entry and validation of a password.

It should be noted that in accordance with an alternative embodiment of the invention, the user validation may be the voice of the user, where the server 200 is capable of validating the user by analyzing the voice of the user. Due to real-time transmission of high quality audio provided by the present communication system, remote user validation is made possible.

If user validation is successful, the client NetMic 100 and the server NetMic 150 establish communication with each other (block 404). To establish communication between the client NetMic 100 and the server NetMic 150, the connection software 220 causes the server 200 to query the storage device 290 for the identity of the client NetMic 100 associated with the client computer 140, and the identities of the server 200 and the server NetMic 150. The connection software 220 then requests initiation of the client NetMic 100 communicating with the server NetMic 150 and the server NetMic 150 communicating with the client NetMic 100. As an example, user datagram protocol (UDP) commands may be transmitted over the network to the client NetMic 100 to cause it to establish communication with the server NetMic 150.

In addition, with successful validation, the connection software 220 initiates launching of ASR software 225 session between the server 200 and the client computer 140 (block 406). The ASR software 225 session includes retrieving user voice files associated with the validated user, for use by the ASR software 225 during transcription. Thereafter, terminal service session data is communicated to/from the server 200 over the network 30. Data received by the client computer 140, for displaying on a monitor in communication with the client computer 140, includes speech-to-text results from the ASR software 225.

When the system 10 is ready, which may be shown by different methods, the user speaks into the audio device 20 (block 408). An example of how the communication system 10 may show that it is ready may include the client computer 140 receiving text indicating that the client NetMic 100 is communicating with the server NetMic 150. Of course, other methods may also be used.

Analog audio is then transmitted from the audio device 20 to the client NetMic 100 (block 410). Specifically, the analog audio is received via the microphone jack 104 located on the client NetMic 100. The client NetMic 100 converts the analog audio to digital audio and transmits the digital audio to the server NetMic 150, via the network 30 (block 412). The digital audio is received by the server NetMic 150 via the device server 162. The server NetMic 150 converts the received digital audio into analog audio and transmits the analog audio to the server 200 (block 414). Specifically, the analog audio is transmitted from the server NetMic 150 via the server NetMic line out jack 156, and received by the server 200 via the server line in jack 262. By receiving analog audio signals directly from the server NetMic 150 via the line in jack 262 of the server 200, received analog audio signals are transmitted directly to the sound card 280 resulting in such minimal buffering and/or interference, if any at all, so as to mimic a direct connection from a microphone directly to the sound card 280.

The server 200 then transcribes the received analog audio into text (block 416) using the user specific voice file. While transcribing, transcribed text, which is in analog format, is transmitted from the server 200 to the client computer 140 (block 418). Specifically, transcribed text exits the server 200 via the server network interface connection 282, transmitted via the network 30, and is received by the client computer 140 via the client computer network interface connection 149.

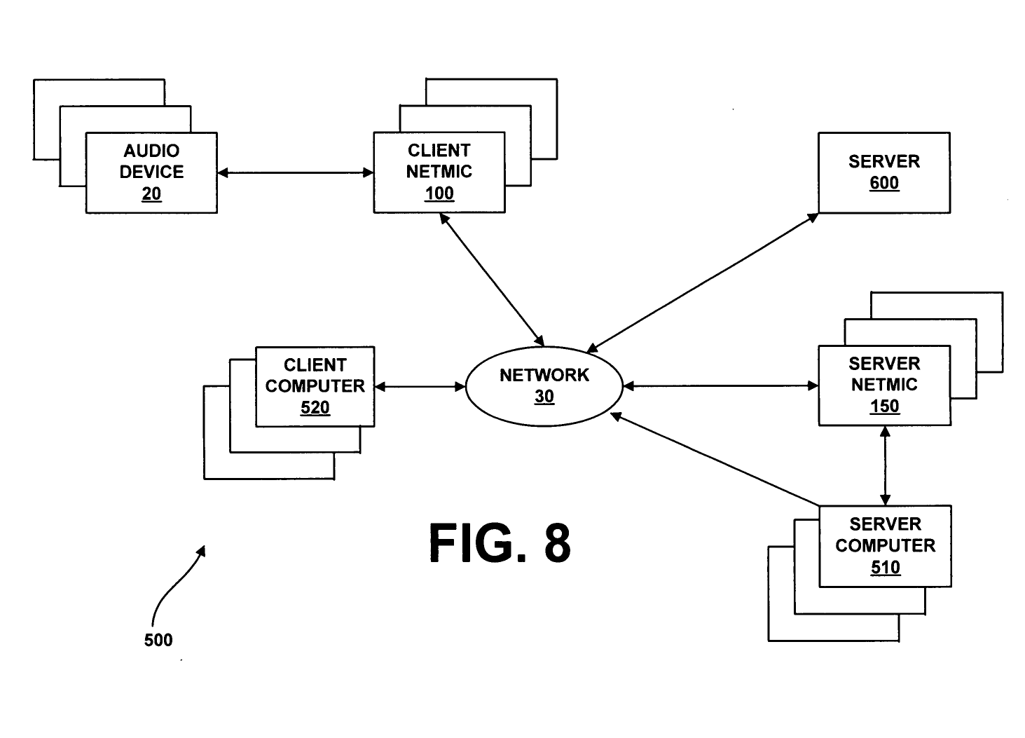

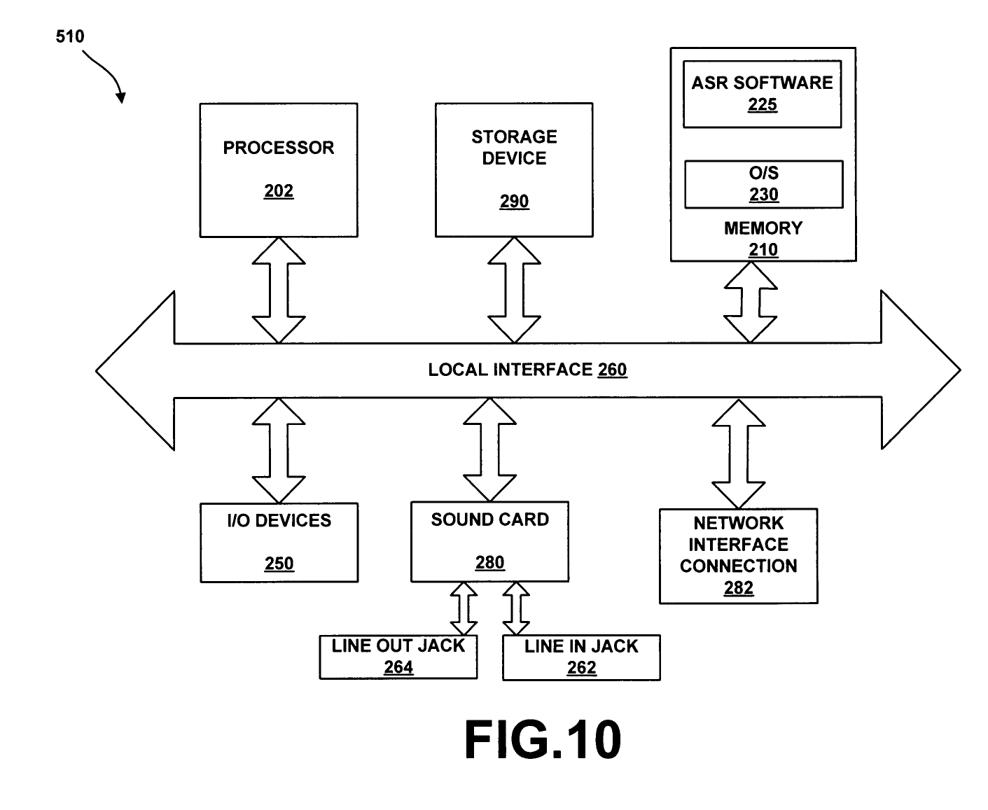

FIG. 8 is a schematic diagram illustrating the communication system 500, in accordance with the second exemplary embodiment of the invention. The second exemplary embodiment system 500 components differ from the first exemplary embodiment system 10 components in that the second exemplary embodiment system 500 contains a series of server computers 510 that perform the transcription services, and a series of server NetMics 150. As is shown by FIG. 10, each server computer 510 has voice files of a single user stored therein and ASR software, so as to allow a single server computer 510 to be dedicated to transcription for a single user. In addition, by having multiple server computers 510 and multiple server NetMics 150, where each server computer 510 is dedicated to providing transcription services for a single user, and each server NetMic 150 is dedicated to a server computer 510 for providing received audio signals to the server computer 510, multiple users can utilize the communication system 500 at the same time. Therefore, contrary to the first exemplary embodiment of the invention where the server performs transcription for a single user at a time, multiple users are accommodated for simultaneously by the second exemplary embodiment of the invention since multiple server computers 510 perform the transcription. It should be noted that the multiple users may also use multiple client computers 520, each of which is assigned one of multiple client NetMics 100. As a result, multiple client computers 520 and multiple client NetMics 100 are illustrated by FIG. 8. In addition, each user may use a separate audio device 20, resulting in FIG. 8 showing multiple audio devices 20.

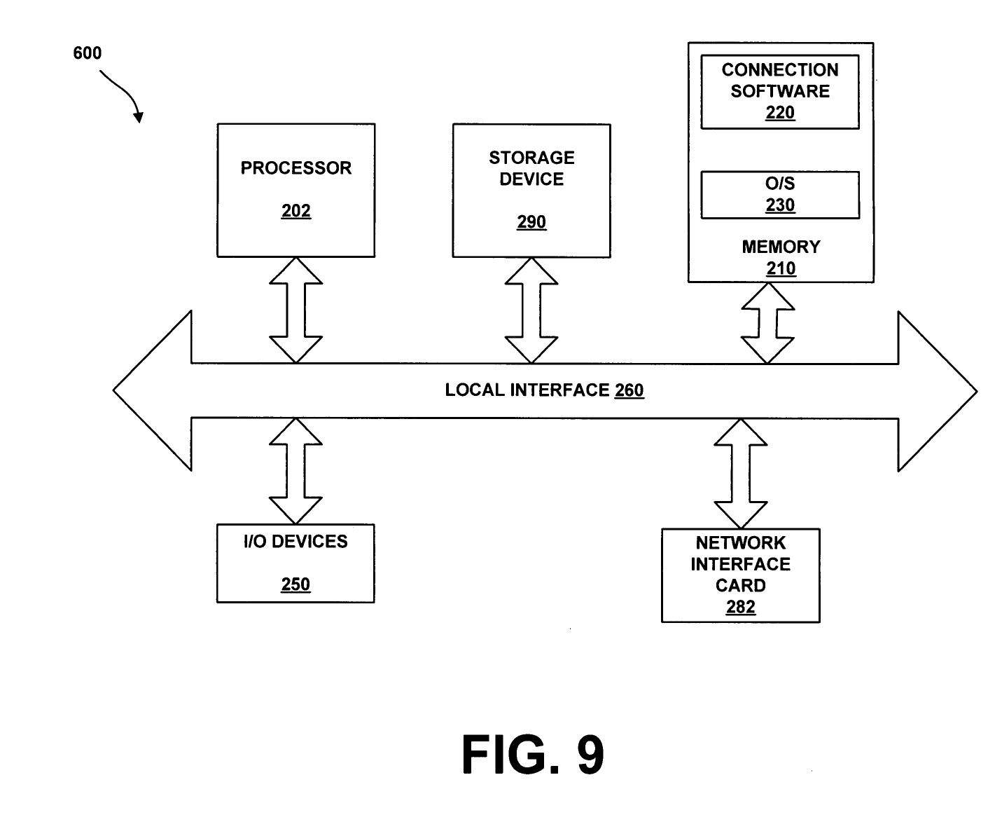

The server 600 of FIG. 8 is similar to the server 200 of the first exemplary embodiment of the invention, except that user voice files are not stored on the server 600, and the ASR software is also not stored within the server 600. Since the client NetMic 100 and the server NetMic 150 are the same in the second exemplary embodiment of the invention, further description of the same is not provided herein. Instead, reference may be made to the detailed descriptions of the client NetMic 100 and the server NetMic 150 provided hereinabove with regard to the first exemplary embodiment of the invention. It should be noted, however, that since there is more than one server NetMic 150, a single server NetMic 150 is assigned to a single server computer 510 FIG. 9 is a block diagram further illustrating the server 600 of FIG. 8. Generally, in terms of hardware architecture, the server 600 includes at least one processor 202, a memory 210, a storage device 290, and one or more input and/or output (I/O) devices 250 (or peripherals) that are communicatively coupled via a local interface 260. The connection software 220 is stored in the memory 210 for establishing communication paths within the system 500, as well as the O/S 230. As mentioned below, since the individual user voice files are stored on each server computer 510, the server 600 does not have the user voice files stored within the storage device 290. In addition, since the ASR software is stored on each server computer 510, the server 600 does not have the ASR software stored within the memory 210. Further, the sound card, line in jack and line out jack are also not located within the server of FIG. 9, but instead, within each server computer 510.

FIG. 10 is a block diagram further illustrating a single server computer 510 of the series of server computers, in accordance with the second exemplary embodiment of the invention. Generally, in terms of hardware architecture, the server computer 510 includes at least one processor 202, a memory 210, and one or more input and/or output (I/O) devices 250 (or peripherals) that are communicatively coupled via a local interface 260.

The processor 202 is a hardware device for executing ASR software 225, particularly that stored in the memory 210. The memory 210 may also contain a suitable operating system (O/S) 230 known to those having ordinary skill in the art. The I/O devices 250 may include input devices, for example but not limited to, a keyboard, mouse, scanner, microphone, and other devices. Furthermore, the I/O devices 250 may also include output devices, for example but not limited to, a printer, display, and other devices. Finally, the I/O devices 250 may further include devices that communicate both as inputs and outputs, for instance but not limited to, a modulator/demodulator (modem; for accessing another device, system, or network), a radio frequency (RF) or other transceiver, a telephonic interface, a bridge, a router, and other devices.

The server computer 510 also contains a separate storage device 290 that, in accordance with the second exemplary embodiment of the invention, is capable of storing the voice files of one user. The individual user specific voice files are used by the ASR software 225 to provide transcription specific to voice characteristics of an individual user. As is described in additional detail hereinbelow, the transcription system 500 is capable of providing automatic transcription for multiple users, through the use of the same client NetMic 100 or different client NetMics 100, where the client NetMics 100 may be located in the same location or in different locations. When a user of the transcription system 500 logs into a client computer 520, a server computer 510 associated with the specific user is accessed. The server computer 510 for the user contains user specific voice files, which are accessed to allow transcription by the ASR software 225 stored within the server computer 510. Specifically, one server computer 510 is associated with one user, thereby providing the capability of multiple users using the transcription system 500 at the same time, and each obtaining transcription services.

It should also be noted that, as with the first exemplary embodiment of the invention, there may be multiple client NetMics 100, multiple client computers 520, and multiple audio devices 20. Additionally, there are multiple server NetMics 150 (as mentioned above), multiple server computers 510 (as mentioned above), and a server 600 within the transcription system 500 of the second exemplary embodiment of the invention.

The server computer 510 also contains a sound card 280, a line in jack 262 and a line out jack 264. The line in jack 262 and the line out jack 264 allow communication from and to the server NetMic 150. The line in jack 262 and line out jack 264 of the server computer 510 allow for direct communication from the server NetMic 150 to the sound card 280 located within the server computer 510. Since the ASR software 225 is a high-accuracy, voice centric application, the NetMics 100, 150 are required to provide uncompressed, or lossless audio to achieve maximum performance and accuracy from the ASR software 225. These qualities are maintained by the NetMics 100, 150, and the connection between the server NetMic 150 and the server computer 510 is a direct wired connection from the server NetMic 150 to the sound card 280.

Alternatively, analog audio may be received from the server NetMic 150 via a universal serial bus (USB) connection located on the server computer 510. By providing communication capability between the server computer 510 and server NetMic 150 via either a line in jack 262, a line out jack 264, or a USB connection, a direct analog communication channel is provided between the server computer 510 and the server NetMic 150. Since direct communication with the sound card 280 provides immediate receipt of analog audio signals, there is no delay in received analog audio signals, such as is characteristic of audio signals received from a network connection. After receipt by the sound card 280, received analog audio signals are transcribed in accordance with functionality defined by the ASR software 225.

The server computer 510 also contains a network interface connection 282, or other means of communication, for allowing the server computer 510 to communicate with the server 600, the network 30, and other portions of the system 500. Since network interface connections 282 are known to those having ordinary skill in the art, further description is not provided herein.

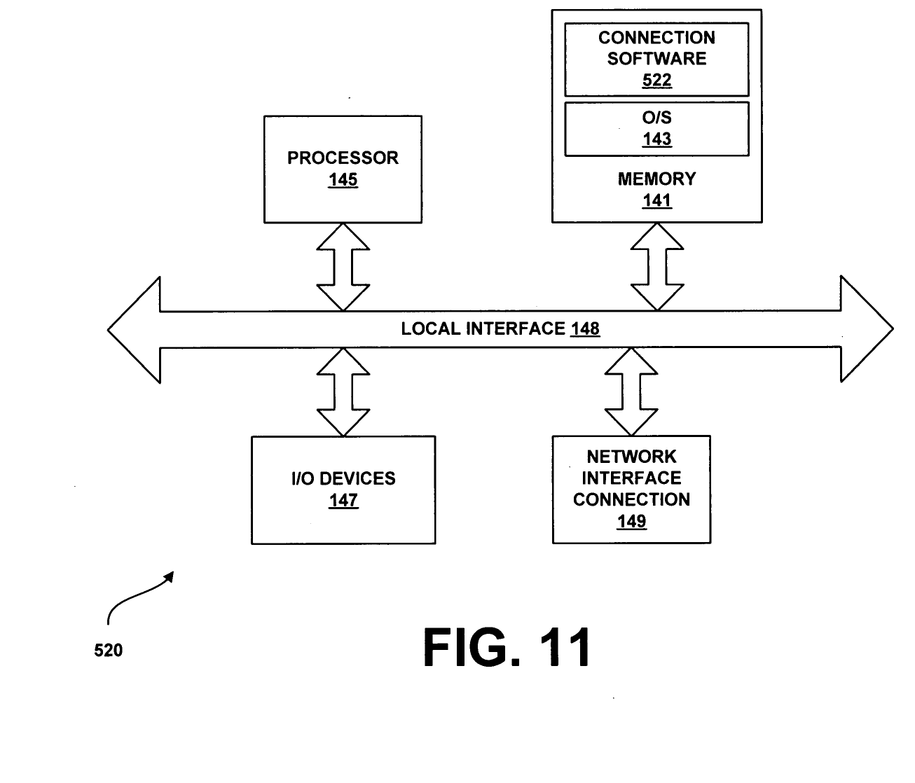

FIG. 11 is a block diagram of the client computer 520 of FIG. 8, in accordance with the second exemplary embodiment of the invention. As is shown by FIG. 11, the client computer 520 has a memory 141 with an O/S 143 stored therein, a processor 145, and I/O devices 147, each of which is capable of communicating within the client computer 520 via a local interface 148. The client computer 520 also contains a device for communication with the network 30, such as, but not limited to, a network interface connection 149. Since basic descriptions of a memory 141, an O/S 143, a processor, I/O devices 147, and a local interface 148 have been provided hereinabove, further description is not provided herein. In accordance with an alternative embodiment of the invention, the client computer 250 may also contain a storage device therein.

In accordance with the second exemplary embodiment of the invention, the user does not log into a remote server. Instead, connection software 522 is also stored on the client computer 520. The user of the client computer 520 interacts with the connection software 522 via a monitor connected to the client computer 520, for viewing, and an input device that allows the user to make selections or enter information, as required by the connection software 522. The connection software 522 stored within the client computer 520 is also capable of communicating with the connection software 220 stored on the server 600 for providing communication capability of the system 500.

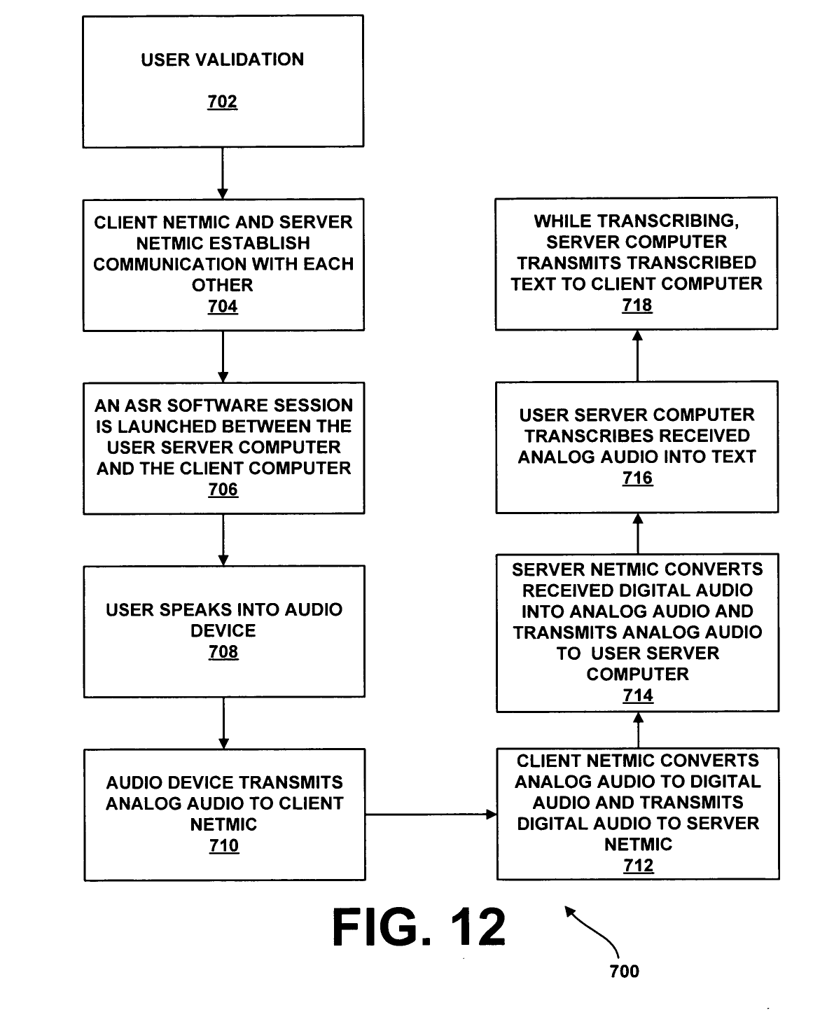

FIG. 12 is a flow chart 700 illustrating use of the transcription system 500, in accordance with the second exemplary embodiment of the invention. As is shown by block 702, a user is validated for access to the server 600 (i.e., use of the system 500). For the user validation process, a user of the connection system 500 logs into their client computer 520, which is capable of communicating with the server 600. Specifically, the user uses the connection software 522 stored on the client computer 520 to log in. Thereafter, the connection software 522 stored within the client computer 520 communicates with the connection software 220 stored at the server 600. The server 600 receives the user identification and validates that the user identification is valid. Results of the user identification validation are displayed by a monitor or other output device in communication with the client computer 520. The validation process may also require entry and validation of a password.

If user validation is successful, the client NetMic 100 and the server NetMic 150 establish communication with each other (block 704). To establish communication between the client NetMic 100 and the server NetMic 150, the connection software 220 stored within the server 600 causes the server 600 to query the storage device 290 for the identity of the client NetMic 100 associated with the client computer 520, and the identity of the server NetMic 150 associated with the server computer 510. The connection software 220 of the server 600 then requests initiation of the client NetMic 100 communicating with the server NetMic 150, and the server NetMic 150 communicating with the client NetMic 100. As an example, user datagram protocol (UDP) commands may be transmitted over the network to the client NetMic 100 to cause it to establish communication with the server NetMic 150. In addition, UDP commands may be transmitted over the network to the server NetMic 150 to cause it to establish communication with the client NetMic 100.

In addition, with successful validation, the connection software 220 initiates launching of an ASR software 225 session between the server computer 510 associated with the user, and the client computer 520 (block 706). The ASR software 225 session includes retrieving user voice files associated with the validated user, which are stored in the server computer 510 storage device 290, for use by the ASR software 225 during transcription. A terminal session between the server computer 510 and the client computer 520 is also initiated, resulting in terminal service session data being communicated to/from the server computer 510 over the network 30. Data received by the client computer 520, for displaying on a monitor in communication with the client computer 520, includes speech-to-text results from the ASR software 225.

When the system 500 is ready, the user speaks into the audio device 20 (block 708). Analog audio is then transmitted from the audio device 20 to the client NetMic 100 (block 710). Specifically, the analog audio is received via the microphone jack 104 located on the client NetMic 100. The client NetMic 100 converts the analog audio to digital audio and transmits the digital audio to the server NetMic 150, via the Network 30 (block 712). The digital audio is received by the server NetMic 150 via the device server 162. The server NetMic 150 converts the received digital audio into analog audio and transmits the analog audio to the server computer 510 associated with the user (block 714). Specifically, the analog audio is transmitted from the server NetMic 150 via the server NetMic line out jack 156, and received by the server computer 510 via the line in jack 262. Since the line in jack 262 is connected directly to the soundcard 280, there is no delay, buffering, or interference during receiving of analog audio by the server computer 510.

The server computer 510 then transcribes the received analog audio into text (block 716) using the user specific voice files. While transcribing, transcribed text, which is in analog format, is transmitted from the server computer 510 to the client computer 520 (block 718). Specifically, transcribed text exits the server computer 510 via the server network interface connection 282, transmitted via the network 30, and is received by the client computer 520 via the client computer network interface connection 149.

A third exemplary embodiment of the invention is similar to the second exemplary embodiment of the invention (FIG. 8), however, location of the user voice files is different. Specifically, the user voice files may be located remote from the user server computer and retrieved when required by the server computer for transcription purposes. As an example, all, or some of the voice files may be stored in a location remote from the server computers (e.g., the server storage device or elsewhere), where the server computer for user 1 retrieves voice files for user 1 prior to transcription.

A fourth exemplary embodiment of the invention is similar to the third exemplary embodiment of the invention (FIG. 8), however, more than one user is assigned to the same server computer. When a first user logs into the system, voice files for that user are retrieved for use by the server computer. The voice files may be located locally on the server computer, or remote from the server computer. After completion of transcription for the first user, a second user can log into the communication system and use the same server computer for transcription. When the second user is logged into the system, the server computer retrieves the voice files for the second user, for use in transcription by the server computer. In this embodiment, a single server computer can be used for different users, thereby providing the capability of having multiple server computers that can provide transcription services for different users.

To assist in minimizing latency in the systems of the abovementioned embodiments of the invention, the CODECs of the NetMics are synchronized and byte alignment for audio samples transmitted between NetMics, is performed by the DSPs of the NetMics. Specifically, since the CODECs do not have the same internal clock speed, synchronization is necessary. Synchronizing of the CODECS and byte alignment are described in detail below. Since the present system provides a full duplex audio transmission, synchronization and byte alignment is performed by the client NetMic when receiving audio samples from the server NetMic, and by the server NetMic, when receiving audio samples from the client NetMic.

As is known to those having ordinary skill in the art, DSPs contain buffers that temporarily hold received audio samples. In accordance with the present systems, the DSPs temporarily hold received audio samples prior to transmitting the audio samples to the CODECS. Specifically, audio samples received by a receiving NetMic are received at the rate of transmission of a transmitting NetMic. In addition, a CODEC has a rate of sampling, which defines a rate at which the CODEC is capable of receiving audio samples. Unfortunately, the rate at which audio samples are received by a NetMic is typically not the same as the rate of sampling of an associated CODEC. As a result, received audio samples are temporarily stored within the DSP until the CODEC is ready to receive the audio samples, which is known by the DSP. If the DSP is receiving audio samples faster than the CODEC is capable of receiving the audio samples, the DSP knows that it has to discard audio samples in order to prevent overflowing of a buffer located within the DSP. In addition, if the DSP is receiving audio samples slower than the CODEC is capable of receiving the audio samples, the DSP knows that it has to add audio samples in order to provide audio samples to the CODEC in accordance with the processing speed of the CODEC.

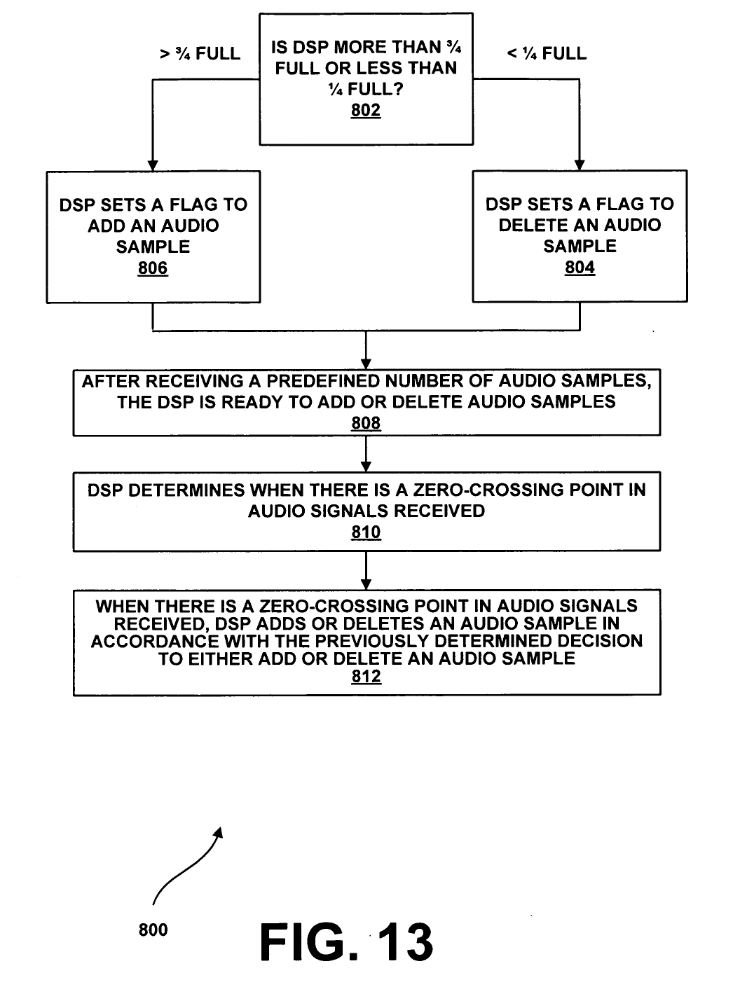

Synchronization of a CODEC is performed by the DSP located within the same NetMic, and is illustrated in accordance with the flowchart 800 of FIG. 13. As is shown by block 802, each time that an audio sample is received by the DSP, the DSP determines if the buffer within the DSP is more than three-quarters full or less than a quarter full. It should be noted that in accordance with alternative embodiments of the invention, the DSP may determine when the buffer is more than a different percentage full and less than a different percentage full. If the buffer is more than three-quarters full, the DSP sets a flag to delete an audio sample from the audio samples that are going to be provided to the CODEC (block 804). Alternatively, if the buffer is less than a quarter full, the DSP sets a flag to add an audio sample to the audio samples that are going to be provided to the CODEC (block 806). When the buffer is not less than a quarter full or more than three quarters full, the DSP leaves the state of the flag unchanged.

As is shown by block 808, after a predefined number of audio samples have been received by the DSP, the DSP is ready to add or delete an audio sample. The DSP then determines when there is a zero-crossing point in audio signals received (block 810). When there is a zero-crossing point in audio signals received, the DSP adds or deletes an audio sample in accordance with the previously determined decision to either add or delete an audio sample (block 812).

It should be noted that since the CODEC accepts 16-bit audio samples, and a network accepts 8-bit audio samples, it is necessary to divide the 16-bit audio samples into two 8-bit audio samples. Specifically, the 16-bit audio sample is divided into a high order 8-bit audio sample and a low order 8-bit audio sample. With transmission of the two 8-bit audio samples, for correct arrangement of received low and high order 8-bit audio samples, it is necessary to ensure whether a received 8-bit audio sample is a high or low order 8-bit audio sample. Unfortunately, if the low and high order 8-bit audio samples are not aligned properly, received audio samples will not be understandable. Of course, use of a 16-bit audio sample is exemplary. Other sizes of audio samples may be provided for by the present system and method.

To alleviate the abovementioned problem with aligning low and high order audio samples, the DSP of the transmitting NetMic inserts a predefined bit pattern into the audio sample stream to the receiving NetMic. If the DSP of the transmitting NetMic detects the predefined bit pattern in the audio sample received from the CODEC, these audio samples are modified slightly so as not to cause the predefined bit pattern to be transmitted. The predefined bit pattern instructs the DSP of the receiving NetMic that the next audio sample to be received by the receiving NetMic will be either a low order audio sample or a high order audio sample. If the receiving NetMic knows if the next received audio sample will be a low order audio sample or a high order audio sample, the DSP of the receiving NetMic can align received audio samples accordingly. Specifically, the DSP of the receiving NetMic has a flag that toggles in designating a received audio sample as a high order byte, then a low order byte, then a high order byte and so on in a repeating fashion. Unfortunately, it is possible that the toggle may be off after a period of time, resulting in inaccurate designation of high order audio samples and low order audio samples. As a result, when the DSP of the receiving NetMic receives the predefined bit pattern, the receiving DSP knows whether the next received audio sample will be a low order audio sample or a high order audio sample and the receiving DSP adjusts alignment if necessary.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A system for providing real-time communication of high-quality audio, comprising:
an audio device;
at least one client device in communication with said audio device, said client device being capable of converting analog signals received from said audio device, into digital data;
a network for allowing communication within said system;
at least one server device capable of communicating with said client device via said network, said server device being capable of converting digital data received from said client device, into analog signals; and
a server in communication with said server device and said network, said server having a sound card, a connection between said server device and said server resulting in analog signals from said server device being directly received by said sound card located within said server.

2. The system of claim 1, further comprising at least one client computer capable of communicating with said server via said network, said client computer containing a means for allowing a user of said client computer to provide user information and a screen for displaying text received from said server.

3. The system of claim 2, wherein said server further comprises automatic speech recognition (ASR) software, said ASR software being capable of being used to transcribe said received analog signals, with respect to a user voice file, into said text for transmission to said client computer via said network.

4. The system of claim 3, wherein said user voice file is located within a storage device of said server.

5. The system of claim 3, where said user voice file is located remote from said server and retrieved by said server for transcription of said analog signals.

6. The system of claim 3, wherein said server and said client computer each further comprise a memory and a processor, wherein said memory of said server and said memory of said client computer further comprise connection software stored therein, and wherein said processor of said server and said processor of said computer are configured by said connection software to perform the steps of:
defining an audio signal transmission path from said client device to said server device; and
specifying relationships between said client computer and said client device resulting in said transcribed text associated with said digital data transmitted by said client device, being transmitted to said client computer.

7. The system of claim 3, where said ASR software is also capable of determining identity of a user that derived the received audio signals.

8. The system of claim 3, wherein said server further comprises a second ASR software stored within said server that is capable of determining identity of a user that derived the received audio signals.

9. The system of claim 1, wherein said client device further comprises:
means for communicating with said audio device;
an encoder/decoder (CODEC) connected to said means for communicating with said audio device, said CODEC capable of converting analog signals received via the means for communicating into digital data;
a digital signal processor connected to said CODEC, said digital signal processor capable of performing data conversion of full-duplex serial digital audio streams; and
a device server connected to said digital signal processor, said device server capable of converting asynchronous serial data received from the digital signal processor to streaming Internet Protocol (IP) packets.

10. The system of claim 9, wherein said digital signal processor (DSP) further comprises a buffer, and wherein said DSP of said client device is capable of performing the steps of:
when an audio sample is received by said DSP, determining when said buffer is more than a percentage X full and less than a percentage Y full;
if said buffer is more than percentage X full, said DSP setting a flag to delete an audio sample from audio samples that are to be provided to said CODEC;
if said buffer is less than percentage Y full, said DSP setting said flag to add an audio sample to said audio samples that are going to be provided to said CODEC; and
if said buffer is not more than percentage X full and not less than percentage Y full, said DSP leaving a state of said flag unchanged.

11. The system of claim 10, wherein said DSP of said client device is also capable of performing the step of, after a predefined number of audio samples have been received by said DSP, said DSP being ready to add or delete an audio sample, and when there is a zero-crossing point in audio signals received, said DSP adding or deleting audio samples in accordance with said set flag.

12. The system of claim 9, wherein said digital signal processor (DSP) of said client device is capable of performing byte alignment, said byte alignment comprising the steps of:
inserting a predefined bit pattern into an audio sample stream being transmitted to said server device, said bit pattern representing that a next received audio sample will be either a low order audio sample or a high order audio sample;
transmitting said predefined bit pattern to said server device; and
adjusting byte alignment if necessary within said client device if a predefined bit pattern is received.

13. The system of claim 9, wherein said means for communicating with said audio device is a wireless communication device.

14. The system of claim 9, wherein said means for communicating with said audio device comprises a microphone jack and a speaker jack.

15. The system of claim 1, wherein said connection between said server device and said server is provided by a line in jack and a line out jack of said server device, and a line in jack and a line out jack of said server.

16. The system of claim 1, wherein said connection between said server device and said server is a wireless connection comprising a first wireless communication device located within said server device and a second wireless communication device located within said server, wherein said second wireless communication device is directly connected to said soundcard.

17. The system of claim 1, wherein said network is selected from the group consisting of a local area network and a wide area network.

18. The system of claim 1, wherein said server device further comprises:
means for communicating with said server;
a digital signal processor, said digital signal processor capable of performing data conversion of full-duplex serial digital audio streams;
a server device encoder/decoder (CODEC) connected to said means for communicating with said server and connected to said digital signal processor, said server device CODEC capable of converting digital data received via said digital signal processor into analog signals; and
a device server connected to said digital signal processor, said device server capable of converting streaming Internet Protocol packets of data received from said network, into asynchronous serial data.

19. The system of claim 18, wherein said digital signal processor (DSP) further comprises a buffer, and wherein said DSP of said server device is capable of performing the steps of:
when an audio sample is received by said DSP, determining when said buffer is more than a percentage X full and less than a percentage Y full;
if said buffer is more than percentage X full, said DSP setting a flag to delete an audio sample from audio samples that are to be provided to said CODEC, if said buffer is less than percentage Y full, said DSP setting said flag to add an audio sample to said audio samples that are going to be provided to said CODEC; and
if said buffer is not more than percentage X full and not less than percentage Y full, said DSP leaving a state of said flag unchanged.

20. The system of claim 19, wherein said DSP of said server device is also capable of performing the step of, after a predefined number of audio samples have been received by said DSP, said DSP being ready to add or delete an audio sample, and when there is a zero-crossing point in audio signals received, said DSP adding or deleting audio samples in accordance with said set flag.

21. The system of claim 18, wherein said digital signal processor (DSP) of said server device is capable of performing byte alignment, said byte alignment comprising the steps of:
inserting a predefined bit pattern into an audio sample stream being transmitted to said client device, said bit pattern representing that a next received audio sample will be either a low order audio sample or a high order audio sample;
transmitting said predefined bit pattern to said client device; and
adjusting byte alignment if necessary within said server device if a predefined bit pattern is received.

22. A system for providing real-time communication of high-quality audio, comprising:
a series of audio devices;
a series of client devices, each one of said client devices in communication with one of said audio devices, each one of said client devices being capable of converting analog signals received from one audio device of said series of audio device, into digital data;
a network for allowing communication within said system;
a series of server devices, each one of said service devices being capable of communicating with one of said series of client devices via said network, each one of said server devices being capable of converting digital data received from one client device of said series of client devices, into analog signals; and
a series of server computers, each of said server computers having a sound card, a connection between one of said series of server devices and one of said series of server computers resulting in analog signals from said one of said series of server devices being directly received by said sound card located within said one of said series of server computers.

23. The system of claim 22, further comprising a series of client computers, wherein each client computer within said series of client computers is capable of communicating with one server computer of said series of server computers via said network, said each client computer containing a means for allowing a user of said each client computer to provide user information and a screen for displaying text received from said one of said series of server computers.

24. The system of claim 23, further comprising a server connected to said network, wherein said server, each client computer within said series of client computers, and each server computer of said series of server computers, each further comprise a memory and a processor, wherein said memory of said server, said memory of said each client computer, and said memory of said each server computer further comprises connection software stored therein, and wherein said processor of said server, said processor of said each client computer, and said processor of said each server computer is configured by said connection software to perform the steps of:
defining an audio signal transmission path from one client device of said series of client devices to one server device of said series of server devices; and
specifying relationships between one client computer of said series of client computers and one client device of said series of client devices resulting in said transcribed text associated with said digital data transmitted by said one of said series of client devices, being transmitted to said one of said series of client computers.

25. The system of claim 24, wherein each server computer of said series of server computers further comprises automatic speech recognition (ASR) software, said ASR software being capable of transcribing said received analog signals, with respect to a user voice file, into said text for transmission to a client computer of said series of client computers that is associated with said one client device from which said analog signals were originally derived.

26. The system of claim 25, wherein said user voice file is located within a storage device of said one server computer.

27. The system of claim 25, wherein said user voice file is located remote from said one server computer and retrieved by said one server computer for transcription of said analog signals.

28. The system of claim 25, wherein said ASR software is also capable of determining identity of a user that derived the received analog signals.

29. The system of claim 25, where each of said server computers further comprises a second ASR software that is capable of determining identity of a user that derived the received analog signals.

30. The system of claim 22, wherein said each client device further comprises:
means for communicating with one of said series of audio devices;
an encoder/decoder (CODEC) connected to said means for communicating with said one of said audio devices, said CODEC capable of converting analog signals received via the means for communicating into digital data;
a digital signal processor connected to said CODEC, said digital signal processor capable of performing data conversion of full-duplex serial digital audio streams; and
a device server connected to said digital signal processor, said device server capable of converting asynchronous serial data received from the digital signal processor to streaming Internet Protocol (IP) packets.

31. The system of claim 30, wherein said digital signal processor (DSP) further comprises a buffer, and wherein said DSP of said client device is capable of performing the steps of:
when an audio sample is received by said DSP, determining when said buffer is more than a percentage X full and less than a percentage Y full;
if said buffer is more than percentage X full, said DSP setting a flag to delete an audio sample from audio samples that are to be provided to said CODEC;
if said buffer is less than percentage Y full, said DSP setting said flag to add an audio sample to said audio samples that are going to be provided to said CODEC; and
if said buffer is not more than percentage X full and not less than percentage Y full, said DSP leaving a state of said flag unchanged.

32. The system of claim 31, wherein said DSP of said client device is also capable of performing the step of, after a predefined number of audio samples have been received by said DSP, said DSP being ready to add or delete an audio sample, and when there is a zero-crossing point in audio signals received, said DSP adding or deleting audio samples in accordance with said set flag.

33. The system of claim 30, wherein said digital signal processor (DSP) of said client device is capable of performing byte alignment, said byte alignment comprising the steps of:
inserting a predefined bit pattern into an audio sample stream being transmitted to said server device, said bit pattern representing that a next received audio sample will be either a low order audio sample or a high order audio sample;
transmitting said predefined bit pattern to said server device; and
adjusting byte alignment if necessary within said client device if a predefined bit pattern is received.

34. The system of claim 30, wherein said means for communicating with said audio device is a wireless communication device.

35. The system of claim 30, wherein said means for communicating with said audio device comprises a microphone jack and a speaker jack.

36. The system of claim 22, wherein said connection between one of said series of server devices and one of said series of server computers is provided by a line in jack and a line out jack of said server device, and a line in jack and a line out jack of said server computer.

37. The system of claim 22, wherein said connection between one of said server devices and one of said server computers is a wireless connection comprising a first wireless communication device located within said one server device and a second wireless communication device located within said one server computer, wherein said second wireless communication device is directly connected to said soundcard.

38. The system of claim 22, wherein said network is selected from the group consisting of a local area network and a wide area network.

39. The system of claim 22, wherein said server device further comprises:
means for communicating with one of said series of server computers;
a digital signal processor, said digital signal processor capable of performing data conversion of full-duplex serial digital audio streams;
a server device encoder/decoder (CODEC) connected to said means for communicating with said one of said series of server computers and connected to said digital signal processor, said server device CODEC capable of converting digital data received via said digital signal processor into analog signals; and
a device server connected to said digital signal processor, said device server capable of converting streaming Internet Protocol packets of data received from said network, into asynchronous serial data.

40. The system of claim 39, wherein said digital signal processor (DSP) further comprises a buffer, and wherein said DSP of said server device is capable of performing the steps of:
when an audio sample is received by said DSP, determining when said buffer is more than a percentage X full and less than a percentage Y full;
if said buffer is more than percentage X full, said DSP setting a flag to delete an audio sample from audio samples that are to be provided to said CODEC;
if said buffer is less than percentage Y full, said DSP setting said flag to add an audio sample to said audio samples that are going to be provided to said CODEC; and
if said buffer is not more than percentage X full and not less than percentage Y full, said DSP leaving a state of said flag unchanged.

41. The system of claim 40, wherein said DSP of said server device is also capable of performing the step of, after a predefined number of audio samples have been received by said DSP, said DSP being ready to add or delete an audio sample, and when there is a zero-crossing point in audio signals received, said DSP adding or deleting audio samples in accordance with said set flag.

42. The system of claim 39, wherein said digital signal processor (DSP) of said server device is capable of performing byte alignment, said byte alignment comprising the steps of:
inserting a predefined bit pattern into an audio sample stream being transmitted to said client device, said bit pattern representing that a next received audio sample will be either a low order audio sample or a high order audio sample;
transmitting said predefined bit pattern to said client device; and
adjusting byte alignment if necessary within said server device if a predefined bit pattern is received.
